(19) United States
(12) Patent Application Publication
(10) Pub. No.: US 2025/0116240 A1
(43) Pub. Date: Apr. 10, 2025

(54) FUELING SYSTEM CONTROLS INCLUDING ADAPTATION TO FUEL CHARACTERISTICS

(71) Applicant: Cummins Inc., Columbus, IN (US)

(72) Inventors: Anshul Sharma, Columbus, IN (US); Chandan Mahato, Columbus, IN (US)

(21) Appl. No.: 18/906,237

(22) Filed: Oct. 4, 2024

Related U.S. Application Data
(60) Provisional application No. 63/588,302, filed on Oct. 6, 2023.

(51) Int. Cl. F02D 41/30

(52) U.S. Cl. CPC F02D 41/3082; F02D 2200/0602

(57) ABSTRACT

A process includes operating a fuel injector to perform an injection of fuel, sensing a fluid hammer pressure of fuel in the injector generated in response to closing of an injector needle, determining at least one physical characteristic of the fuel in response to the fluid hammer pressure, and controlling operation of the fuel injection system in response to the at least one physical characteristic.

### CROSS-REFERENCE TO RELATED APPLICATION

The present application claims priority to, and the benefit of the filing date of, U.S. Provisional Application Ser. No. 63/588,302 filed on Oct. 6, 2023, which is incorporated herein by reference in its entirety.

### TECHNICAL FIELD

The present application relates to fueling system controls including adaptation to fuel characteristics.

### BACKGROUND

Fueling systems for internal combustion engines may include electronically controlled fuel injectors. Controls for such systems suffer from a number of shortcomings including those respecting accuracy, adaptability, flexibility, precision, reliability, and robustness, among other shortcomings. These and other shortcomings may be compounded by variation in characteristics of fuel provided to such systems which may be unknown a priori. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

One embodiment is a unique fueling system controls including fueling rate shape determination. Further embodiments include unique apparatuses, systems, and processes comprising or embodying such controls. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an engine system.

FIG. 2 is a schematic diagram illustrating certain further aspects of an example embodiment of the system of FIG. 1.

FIG. 3 is a flow diagram illustrating certain aspects of an example process.

FIG. 4 depicts graphs illustrating certain aspects of example operations.

FIG. 5 is a schematic diagram illustrating certain aspects of example controls.

FIG. 6 is a schematic diagram illustrating certain aspects of example controls.

FIG. 7 is a schematic diagram illustrating certain aspects of example controls.

### DETAILED DESCRIPTION OF EXAMPLE EMBODIMENTS

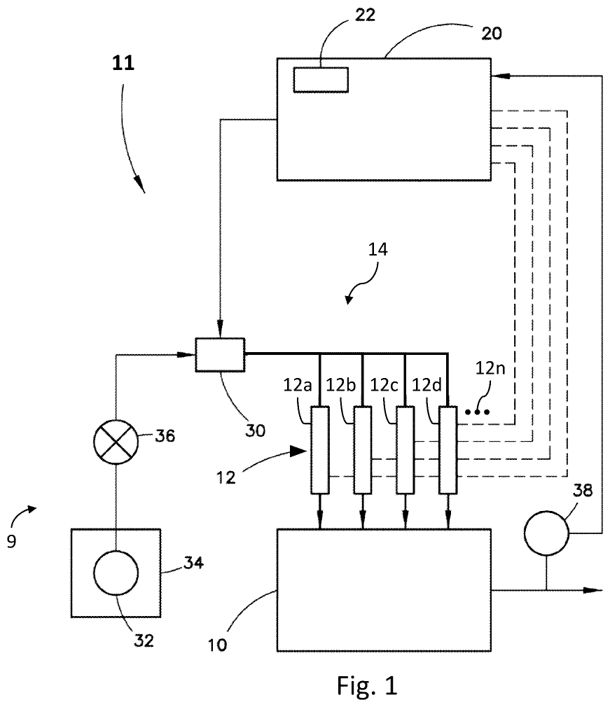

With reference to FIG. 1, there is illustrated a system 11 comprising an engine 10 including a fueling system 9. The engine 10 may be an internal combustion engine, including but not limited to a compression-ignition engine, using diesel or other suitable fuel, or a spark-ignition engine, using gasoline, natural gas, or other suitable fuels. Engine 10 may have one or more combustion cylinders (not depicted) to generate mechanical power from the combustion of a fuel. The fuel injectors 12 are in fluid communication with respective combustion cylinders of the engine 10 and are structured to introduce the fuel into respective combustion cylinders. Though four fuel injectors 12 are depicted in FIG. 1, engine 10 may include fewer or greater numbers of fuel injectors 12 as denoted by ellipsis 12n. In some embodiments, engine 10 may include one fuel injector for each cylinder. In some embodiments, engine 10 may include multiple fuel injectors for each cylinder.

In the illustrated embodiment, the fueling system 9 is configured and provided as a high-pressure fuel injection system including a plurality of fuel injectors 12 in fluid communication with a high-pressure fuel supply 14, which supplies fuel at relatively high-pressure to each fuel injector 12. Fuel may be supplied to the high-pressure fuel supply 14 by a high-pressure pump 30. In certain embodiments, the high-pressure pump may be fed by a relatively low-pressure fuel circuit including a booster pump 32, which may be immersed in a tank 34 containing the fuel. A fuel regulator 36 may control the flow of fuel from tank 34 to the high-pressure pump 30. High-pressure fuel supply 14 may further include a number of other components such as accumulators, dampeners, regulators, valves, and other components, which are not depicted in the illustrated embodiment. In the illustrated embodiment, high-pressure fuel supply 14 is configured and provided as a rail-less fuel supply which supplies high-pressure fuel to injectors 12 without utilizing a common rail-type architecture. In other embodiments, high-pressure fuel supply 14 maybe configured and provided as a common rail fuel supply which supplies high-pressure fuel to injectors 12 utilizing a common rail-type architecture.

System 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include one or more pressure sensors and one or more temperature sensors.

The one or more pressure sensors may be configured and provided to sense fuel pressure within a respective one of the injectors 12 or upstream of a respective one of the injectors 12. The one or more pressure sensors may alternatively or additionally be configured and provided to sense fuel pressure within a common rail of a high-pressure fuel supply in embodiments which include a common rail-type architecture. Regardless of the particular implementation, the one or more pressure sensors may be structured to communicate a measurement of fuel pressure to ECS 20.

The one or more temperature sensors may be configured and provided to sense fuel temperature within a respective one of the injectors 12 or upstream of a respective one of the injectors 12. The one or more temperature sensors may alternatively or additionally be configured and provided to sense fuel temperature within a common rail of a high-pressure fuel supply in embodiments which include a common rail-type architecture. Regardless of the particular implementation, the one or more temperature sensors may be structured to communicate a measurement of fuel temperature to ECS 20.

System 11 may a variety of other sensors including, for example, an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the system 11. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

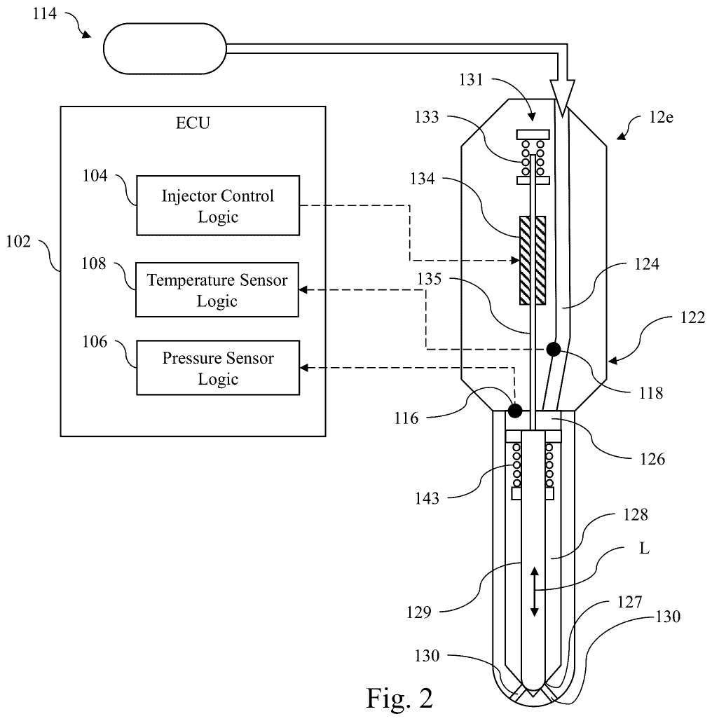

With reference to FIG. 2, there are illustrated further details of an example fuel injector 12e of a type in which any of injectors 12 of system, 11 may be configured and provided. Injector 12e includes a housing 122 which may be configured and provided as a unitary housing or a multipart housing comprising a plurality of housing parts operatively coupled with one another in a liquid-tight manner. A fuel supply passage 124 is defined within the housing 122 and is in fluid communication with and configured to receive pressurized fuel from high-pressure fuel supply 114 which may comprise, for example, the features of high-pressure fuel supply 14 or other high-pressure fuel supplies described in connection with FIG. 1. In the illustrated example, fuel supply passage 124 is depicted as a conduit or passageway it being appreciated that fuel supply passage 124 may comprise a number of additional or alternative components and features such as accumulators, dampeners, regulators, valves, and other components, which are not depicted in the illustrated embodiment.

A pressure chamber 128 is provided within the housing 122 and may be provided with and filled with high-pressure fuel received from fuel supply passage 124. An injector needle 129 is provided in and is longitudinally movable in pressure chamber 128 generally in the directions indicated by arrow L and selectably contacts and moves apart from a needle seat 127 in order to open and close one or more injector holes 130.

A control chamber 126 is provided within housing 122 and is in fluid communication with and configured to receive pressurized fuel from fuel supply passage 124. Control chamber 126 is also in fluid communication with and configured to provide pressurized fuel to pressure chamber 128. A pressure sensor 116 is in operative communication with and configured to measure fuel pressure in the control chamber 126. Pressure sensor 116 is in operative communication pressure sensor logic 106 of electronic control unit (ECU) 102 which may be an implementation of ECU 22 or another ECU. Pressure sensor 116 may be provided in the form of a piezoelectric pressure sensor in other embodiments, pressure sensor 116 may be provided in in operative communication with and configured to measure fuel pressure at other locations of injector 12e such as, for example, a location within fuel supply passage 124 or a location within pressure chamber 128.

A temperature sensor 118 is in operative communication with and configured to measure fuel pressure in the fuel supply passage 124. Temperature sensor 118 is in operative communication with temperature sensor logic 108 of ECU 102 which may be an implementation of ECU 22 or another ECU. In other embodiments, temperature sensor 118 may be provided in in operative communication with and configured to measure fuel pressure at other locations of injector 12e such as, for example, a location within control chamber 126 or a location within pressure chamber 128.

Injector 12e includes an actuator 131 which includes an electronically controllable actuator 134 which may be configured and provided, for example, in the form of a solenoid and which is in operative communication with and selectably actuatable by injector control logic 104 of and electronic control unit ECU 102. ECU 102 may comprise, for example, the features of ECU 12 or electronic control system components described in connection with FIG. 1.

Actuator 131 includes a biasing spring arrangement 133 and a force transfer member 135 which is operatively coupled with biasing spring arrangement 133 and electronically controllable actuator 134 to selectably transfer opening or closing force to injector needle 129. Biasing spring arrangement 133 is configured and operable to provide force biasing force transfer member 135 and injector needle 129 toward a closed position wherein injector needle 129 contacts needle seat 127 in order and close injector holes 130. Electronically controllable actuator 134 is configured and operable to provide opening force to urge force transfer member 135 and injector needle 129 toward an open position wherein injector needle moves apparat from needle seat 127 in order and open injector holes 130 and provide injection of fuel.

Needle biasing spring arrangement 143 is operatively coupled with injector needle 129 and is configured and operable to provide force biasing injector needle 129 toward a closed position. Opening force provided by electronically controllable actuator 134 may be controlled to overcome the biasing force of biasing spring arrangement 133, biasing spring arrangement 133 and needle biasing spring arrangement 143 as well as hydraulic force which may be imparted on injector needle 129 by pressurized fuel in control chamber 126.

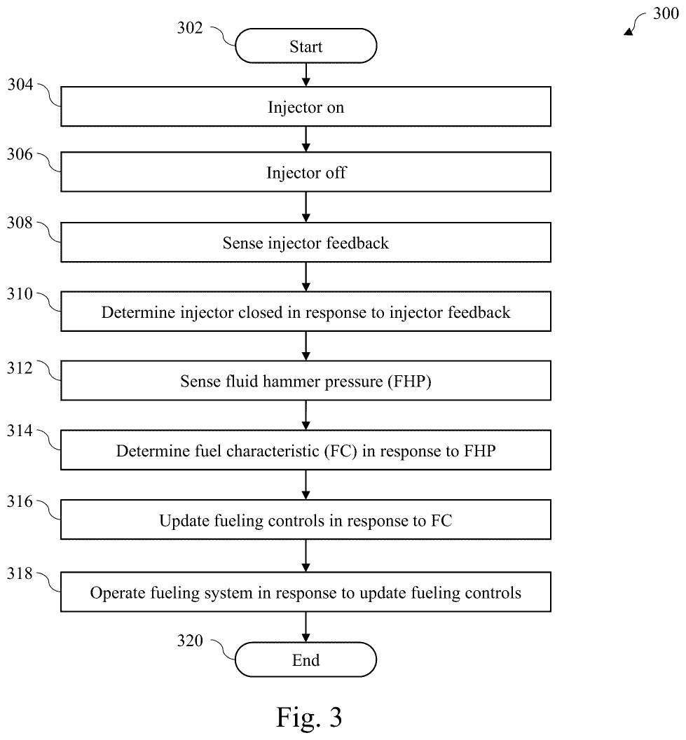

With reference to FIG. 3, there is illustrated an example process 300 operating a fuel injection system. Process 300 may be implemented in and executed by one or more components of an electronic control system such as ECU 22 of ECS 20 or other control components of ECS 20 or of other electronic control systems.

Process 300 begins at start operation 302 and proceeds to operation 304 at which a fuel injector is turned on effective to begin an injection of fuel by opening an injector needle. The turning on of the injector may comprises providing current to an electronically controllable actuator, such as electronically controllable actuator 134 or another electronically controllable actuator, to apply opening force to an injector needle, such as injector needle 129 or another injector needle, causing the injector needle to open, for example, by overcoming a biasing force, such as biasing force provided by biasing spring arrangement 133, needle biasing spring arrangement, and/or hydraulic biasing force, among other components or features that may contribute a biasing force.

From operation 304, process 300 proceeds to operation 306 at which the fuel injector is turned off effective to end an injection of fuel by closing the injector needle. The turning off of the injector may comprises terminating provision of current to the electronically controllable actuator to remove opening force from the injector needle allowing the injector needle to close, for example, in response to the aforementioned biasing forces and components.

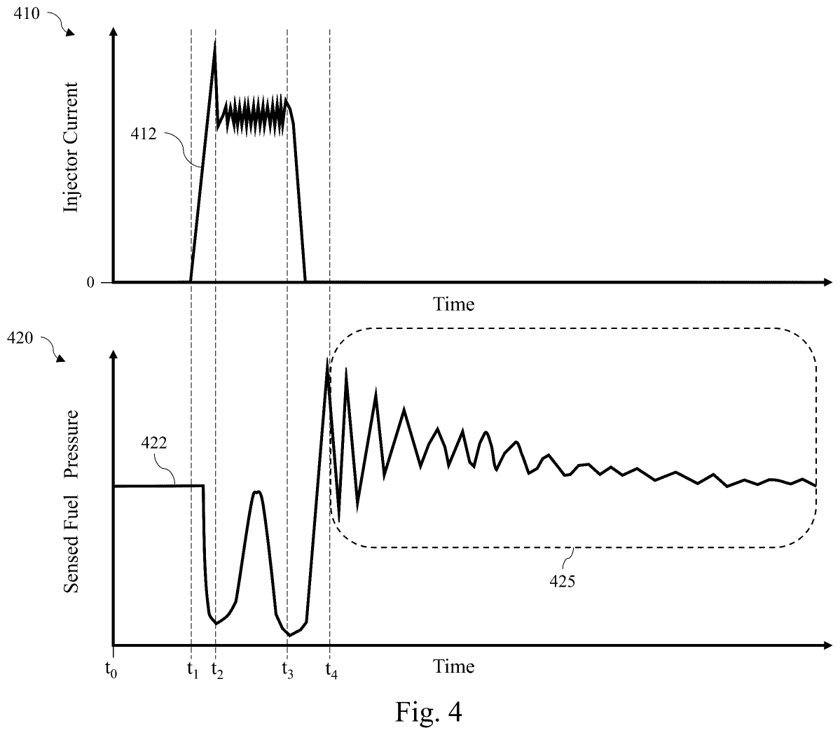

It shall be appreciated that operation 304 and operation 306 are examples of operations effective to operate a fuel injector to perform an injection of fuel including opening an injector needle to begin the injection and closing the injector needle to end the injection. Further aspects of such an example operation are described in connection with FIGS. 4-7.

From operation 306, process 300 proceeds to operation 308 which senses one or more injector feedbacks, for example, a feedback indicative of injector current or a feedback indicative of injector pressure. In some embodiments, operation 308 may be initiated and performed in response to operation 304, operation 306, or another prior operation. In some embodiments, operation 308 may be performed on continually or on an ongoing basis and may be depended on performance of operation 304, operation 306, or other operations.

From operation 308, process 300 proceeds to operation 310 which determines that the injector has closed in response to the injector feedback. Operation 310 may for example, determine that the injector has closed in response to attributes of an injector current and/or and injector pressure associated with injector needle closing.

From operation 310, process 300 proceeds to operation 312 which senses a fluid hammer pressure of fuel in the injector generated in response to the closing the injector needle. The sensing of a fluid hammer pressure of fuel in the injector may be performed by one or more pressure sensors, such as pressure sensor 116 or another pressure sensor. In some embodiments, the sensing of a fluid hammer pressure of fuel in the injector may be performed by a pressure sensor inside of a fuel injector. In some such embodiments, the location inside the fuel injector may comprises a chamber located upstream from the injector needle. Such as control chamber 126 or another chamber.

From operation 312, process 300 proceeds to operation 314 which determines at least one physical characteristic of the fuel in response to the fluid hammer pressure. Operation 315 may determine the at least one physical characteristic by evaluating a waveform of the fluid hammer pressure and determining the at least one physical characteristic in response to the evaluating. The at least one physical characteristic may comprise, for example, a fuel viscosity, a fuel density, or both of a fuel viscosity and a fuel density.

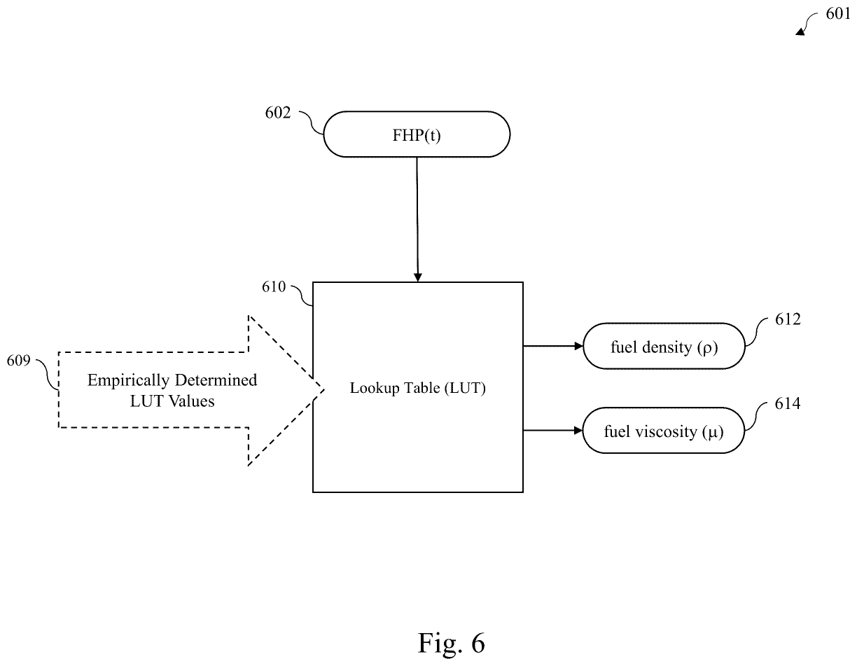

In some embodiments the evaluating may include a time domain waveform evaluation such as the evaluation described in connection with FIG. 6 or other time domain waveform evaluations. In some such embodiments, the frequency domain evaluation may comprise evaluating an amplitude of the fluid hammer pressure.

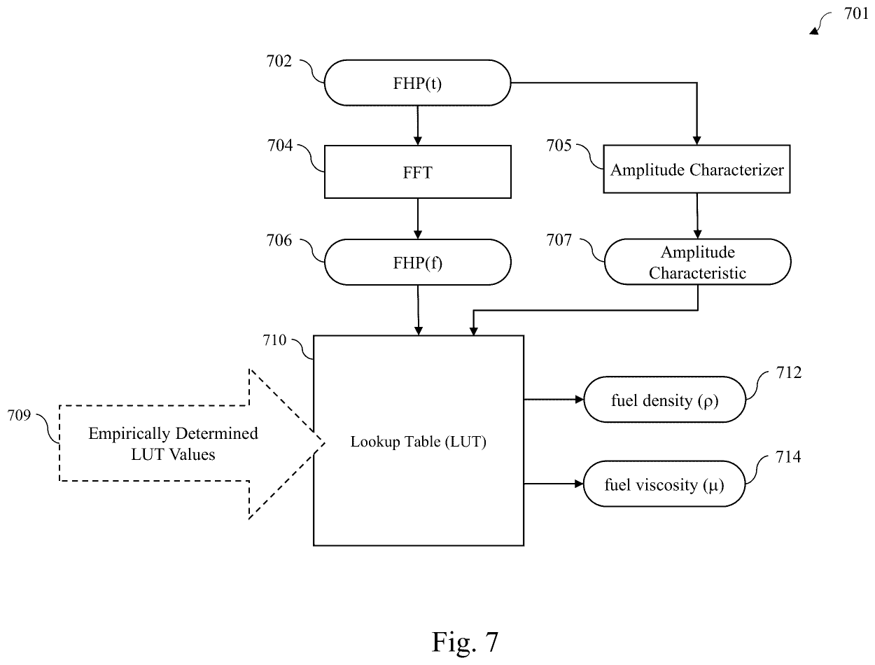

In some embodiments the evaluating may include a frequency domain waveform evaluation such as the evaluation described in connection with FIG. 7 or other frequency domain waveform evaluations. In some such embodiments, the frequency domain evaluation may comprise performing a transform such as a Fast Fourier transform (FFT) and evaluating at least one of a frequency and a wavelength of the fluid hammer pressure and determining the at least one physical characteristic in response to the evaluating. In some such embodiments, the frequency domain evaluation may comprise evaluating an amplitude of the fluid hammer pressure.

From operation 314, process 300 proceeds to operation 316 which may update one or more aspects of fueling controls in response to the at least one physical characteristic of the fuel. From operation 316, process 300 proceeds to operation 318 which operates the fueling system in response to update fueling controls. It shall be appreciated that operation 316 and operation 318 are examples of operations whose performance may be effective to control operation of the fuel injection system in response to the at least one physical characteristic. In some instances or events, the controlling operation of the fuel injection system in response to the at least one physical characteristic may comprise modifying at least one of an injection pressure, and injection quantity, and an injection timing in response to the at least one physical characteristic. Further aspects of such an example operation are described in connection with FIGS. 4-7. From operation 318, process 300 proceeds to end operation 320 and may thereafter be recalled or repeated in connection with one or more other injection events.

With reference to FIG. 4, there are illustrated a graph 410 including a curve 412 depicting an injector current a function of time and a graph 420 including a curve 422 depicting a senses fuel pressure as a function of time. It shall be appreciated that curve 412 may represent a current through an electronically controllable actuator of a fuel injector, such as electronically controllable actuator 134 or another electronically controllable actuator, which may be provided to a microcontroller as a feedback signal indicative of injector current. It shall be appreciated that curve 422 may represent a pressure of fuel in a fuel injector, such as a pressure sensed by pressure sensor 116 or another pressure sensor.

At time t₁, the fuel injector is turned on and injector current 412 begins to rise. After a delay attributable to the inductive load of the injector and momentum of the mass of the injector needle, the injector needle begins to open. At time t₂, injector current 412 reaches a maximum overshoot value and the injector needle has fully opened. Sensed fuel pressure 422 also falls to a minimum value. Thereafter, injector current 412 falls to a hold level and sensed fuel pressure rises. At time t₃, the injector is turned off and injector current begins to fall to zero and the injector needle begins to close. At time t₄, the injector needle fully closes and generates a fluid hammer pressure wave 425 which can be sensed by a pressure sensor.

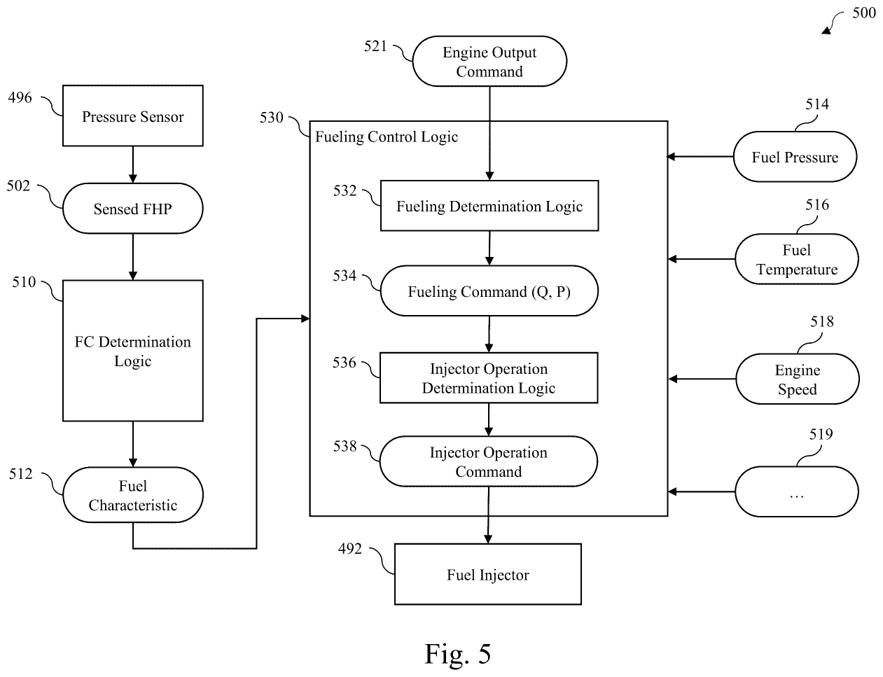

With reference to FIG. 5, there are illustrated example controls 500 which may be implemented in one or more components of an electronic control system, such as ECU 22 and/or other components of ECS 20 or another electronic control system. Controls 500 receive sensed fluid hammer pressure (FHP) information 502 from a pressure sensor 496 which may pressure sensor 116 or another pressure sensor. FHP information 502 is provided to fuel characteristic (FC) determination logic 510 which is configured to determine and output a fuel characteristic 512, for example, using techniques such as those described in connection with FIGS. 6 and 7.

Fuel characteristic 512 is provided to fueling control logic 530 which is also provided with an engine output command 521, fuel pressure 514, fuel temperature 516, engine speed 518, and potentially with one or more additional inputs 519. Fuel pressure 514, may comprise information from the same sensor or sensors that provide sensed FHP 502 relating to different points during an injection process. Additionally or alternatively, fuel pressure 514 may comprise information from one or more different sensors.

Fueling control logic 530 includes fueling determination logic 532 which is configured to determine and provide fueling command 534 including a fueling quantity (Q) and a fueling pressure (P) in response to engine output command 521 and one or more other inputs provided to fueling control logic 530. Fueling determination logic 532 may utilize one or more lookup tables, perform one or more calculations, or utilize other computational logic to determine and provide fueling command 534. Fueling control logic 530 may utilize fuel characteristic 512 to adjust, tune, or otherwise modify the one or more lookup tables, calculations, or other logic utilized.

Fueling control logic 530 further includes injector operation determination logic 536 which is configured to determined and provide an injector operation command 538 in response to the fueling command 534 and one or more other inputs provided to fueling control logic 530. Injector operation determination logic 536 may utilize one or more lookup tables, perform one or more calculations, or utilize other computational logic to determine and provide injector operation command 538. Fueling control logic 530 may utilize fuel characteristic 512 to adjust, tune, or otherwise modify the one or more lookup tables, calculations, or other logic utilized. Injector operation command 538 is provided to and utilized to control fuel injector 492 which may be for example, fuel injector 12e or another fuel injector.

With reference to FIG. 6, there is illustrated an example implementation 601 of FC determination logic 510. Implementation 601 is an example of controls configured to perform a time domain waveform evaluation. In implementation 601, time domain fluid hammer pressure information 602 which may be, for example, FHP information 502, is provided as input (for example as an array, matrix, or vector of inputs) to a lookup table 610 which has been configured with empirically determined LUT values 609 including a plurality of time domain waveforms for a corresponding plurality of fuels and operating conditions, wherein the plurality of fuels provide including variation in at least fuel viscosity and fuel density. Lookup table 610 may utilize one or more characteristics of the time domain fluid hammer pressure information 602 for example, a maximum amplitude, an average amplitude, an amplitude decay rate, and/or wave speed as input values to determine and output fuel density (p) 612 and/or fuel viscosity (u) 614.

With reference to FIG. 7, there is illustrated an example implementation 701 of FC determination logic 510. Implementation 701 is an example of controls configured to perform a frequency domain waveform evaluation. In implementation 701, time domain fluid hammer pressure information 702 which may be, for example, FHP information 502, is provided as input to fast Fourier transform (FFT) operator 704 which is configured and operable to transform the received time domain input to the frequency domain and provide as output frequency domain fluid hammer pressure information 706 which may include, for example, frequency, wavelength, harmonic, amplitude and/or other frequency domain information.

Frequency domain fluid hammer pressure information 706 is provided as input to lookup table 710 which has been configured with empirically determined LUT values 709 including a plurality of frequency domain information for a corresponding plurality of fuels and operating conditions, wherein the plurality of fuels provide including variation in at least fuel viscosity and fuel density. Lookup table 710 may utilize one or more characteristics of the frequency domain fluid hammer pressure information 706, for example, fundamental frequency and amplitude and/or harmonic frequencies and amplitudes to determine and output fuel density (ρ) 712 and/or fuel viscosity (μ) 714.

A first example embodiment is a process of operating a fuel injection system, the process comprising: operating a fuel injector to perform an injection of fuel including opening an injector needle to begin the injection and closing the injector needle to end the injection; sensing a fluid hammer pressure of fuel in the injector generated in response to the closing the injector needle; determining at least one physical characteristic of the fuel in response to the fluid hammer pressure; and controlling operation of the fuel injection system in response to the at least one physical characteristic.

A second example embodiment includes the features of the first example embodiment, wherein the determining comprises evaluating a waveform of the fluid hammer pressure and determining the at least one physical characteristic in response to the evaluating.

A third example embodiment includes the features of the first example embodiment, wherein the determining comprises evaluating at least one of a frequency and a wavelength of the fluid hammer pressure and determining the at least one physical characteristic in response to the evaluating.

A fourth example embodiment includes the features of the first example embodiment, wherein the determining comprises evaluating an amplitude of the fluid hammer pressure and determining the at least one physical characteristic in response to the evaluating.

A fifth example embodiment includes the features of the first example embodiment, wherein the determining comprises evaluating a time domain waveform of the fluid hammer pressure and determining the at least one physical characteristic in response to the evaluating.

A sixth example embodiment includes the features of the first example embodiment, wherein the at least one physical characteristic comprises at least one of a fuel viscosity and a fuel density.

A seventh example embodiment includes the features of the sixth example embodiment, wherein the at least one physical characteristic comprises the fuel viscosity and the fuel density.

An eighth example embodiment includes the features of the first example embodiment, wherein the sensing the fluid hammer pressure comprises sensing a pressure of fuel at a location inside the fuel injector.

A ninth example embodiment includes the features of the eighth example embodiment, wherein the location inside the fuel injector comprises a chamber located upstream from the injector needle.

A tenth example embodiment includes the features of the first example embodiment, wherein the controlling operation of the fuel injection system in response to the at least one physical characteristic comprises modifying at least one of an injection pressure, and injection quantity, and an injection timing in response to the at least one physical characteristic.

An eleventh example embodiment is a system comprising: a fuel injector configured to perform an injection of fuel, the fuel injector comprising an injector needle configured to selectably open and close; a pressure sensor configured to sense a fluid hammer pressure of fuel in the injector generated in response to the closing the injector needle; and an electronic control system in operative communication with the pressure sensor and configured to: control the fuel injector to perform an injection of fuel including opening the injector needle to begin the injection and closing the injector needle to end the injection, determine at least one physical characteristic of the fuel in response to the fluid hammer pressure, and control operation of the fuel injection system in response to the at least one physical characteristic.

A twelfth example embodiment includes the features of the eleventh example embodiment, wherein the electronic control system is configured to perform an evaluation of a waveform of the fluid hammer pressure and to determine the at least one physical characteristic in response to the evaluation.

A thirteenth example embodiment includes the features of the twelfth example embodiment, wherein the evaluation comprises an evaluation of at least one of a frequency and a wavelength of the fluid hammer pressure.

A fourteenth example embodiment includes the features of the twelfth example embodiment, wherein the evaluation comprises an evaluation of an amplitude of the fluid hammer pressure.

A fifteenth example embodiment includes the features of the twelfth example embodiment, wherein the evaluation comprises an evaluation of a time domain waveform of the fluid hammer pressure.

A sixteenth example embodiment includes the features of the twelfth example embodiment, wherein the at least one physical characteristic comprises at least one of a fuel viscosity and a fuel density.

A seventeenth example embodiment includes the features of the sixteenth example embodiment, wherein the at least one physical characteristic comprises the fuel viscosity and the fuel density.

A eighteenth example embodiment includes the features of the eleventh example embodiment, wherein the sensor is configured to sense a pressure of fuel at a location inside the fuel injector.

A nineteenth example embodiment includes the features of the eighteenth example embodiment, wherein the location inside the fuel injector comprises a chamber located upstream from the injector needle.

A twentieth example embodiment includes the features of the eleventh example embodiment, wherein the electronic control system being configured to control operation of the fuel injection system comprises the electronic control system being configured to modify at least one of an injection pressure, and injection quantity, and an injection timing in response to the at least one physical characteristic.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to any of a number of acts, configurations, devices, operations, and techniques, individually or in combination, including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process of operating a fuel injection system, the process comprising:
operating a fuel injector to perform an injection of fuel including opening an injector needle to begin the injection and closing the injector needle to end the injection;
sensing a fluid hammer pressure of fuel in the injector generated in response to the closing the injector needle;
determining at least one physical characteristic of the fuel in response to the fluid hammer pressure; and
controlling operation of the fuel injection system in response to the at least one physical characteristic.

2. The process of claim 1, wherein the determining comprises evaluating a waveform of the fluid hammer pressure and determining the at least one physical characteristic in response to the evaluating.

3. The process of claim 1, wherein the determining comprises evaluating at least one of a frequency and a wavelength of the fluid hammer pressure and determining the at least one physical characteristic in response to the evaluating.

4. The process of claim 1, wherein the determining comprises evaluating an amplitude of the fluid hammer pressure and determining the at least one physical characteristic in response to the evaluating.

5. The process of claim 1, wherein the determining comprises evaluating a time domain waveform of the fluid hammer pressure and determining the at least one physical characteristic in response to the evaluating.

6. The process of claim 1, wherein the at least one physical characteristic comprises at least one of a fuel viscosity and a fuel density.

7. The process of claim 6, wherein the at least one physical characteristic comprises the fuel viscosity and the fuel density.

8. The process of claim 1, wherein the sensing the fluid hammer pressure comprises sensing a pressure of fuel at a location inside the fuel injector.

9. The process of claim 8, wherein the location inside the fuel injector comprises a chamber located upstream from the injector needle.

10. The process of claim 1, wherein the controlling operation of the fuel injection system in response to the at least one physical characteristic comprises modifying at least one of an injection pressure, and injection quantity, and an injection timing in response to the at least one physical characteristic.

11. A system comprising:
a fuel injector configured to perform an injection of fuel, the fuel injector comprising an injector needle configured to selectably open and close;
a pressure sensor configured to sense a fluid hammer pressure of fuel in the injector generated in response to the closing the injector needle; and
an electronic control system in operative communication with the pressure sensor and configured to:
control the fuel injector to perform an injection of fuel including opening the injector needle to begin the injection and closing the injector needle to end the injection,
determine at least one physical characteristic of the fuel in response to the fluid hammer pressure, and
control operation of the fuel injection system in response to the at least one physical characteristic.

12. The system of claim 11, wherein the electronic control system is configured to perform an evaluation of a waveform of the fluid hammer pressure and to determine the at least one physical characteristic in response to the evaluation.

13. The system of claim 12, wherein the evaluation comprises an evaluation of at least one of a frequency and a wavelength of the fluid hammer pressure.

14. The system of claim 12, wherein the evaluation comprises an evaluation of an amplitude of the fluid hammer pressure.

15. The system of claim 12, wherein the evaluation comprises an evaluation of a time domain waveform of the fluid hammer pressure.

16. The system of claim 11, wherein the at least one physical characteristic comprises at least one of a fuel viscosity and a fuel density.

17. The system of claim 16, wherein the at least one physical characteristic comprises the fuel viscosity and the fuel density.

18. The system of claim 11, wherein the sensor is configured to sense a pressure of fuel at a location inside the fuel injector.

19. The system of claim 18, wherein the location inside the fuel injector comprises a chamber located upstream from the injector needle.

20. The system of claim 11, wherein the electronic control system being configured to control operation of the fuel injection system comprises the electronic control system being configured to modify at least one of an injection pressure, and injection quantity, and an injection timing in response to the at least one physical characteristic.
